(19) United States
(12) Patent Application Publication
(10) Pub. No.: US 2023/0407531 A1
(43) Pub. Date: Dec. 21, 2023

(54) COMPOSITE COVER MADE OF HYBRID FIBER REINFORCEMENTS

(71) Applicant: GM GLOBAL TECHNOLOGY OPERATIONS LLC, Detroit, MI (US)

(72) Inventors: Venkateshwar R. AITHARAJU, Troy, MI (US); Bhavesh SHAH, Troy, MI (US); Xiaosong HUANG, Novi, MI (US)

(21) Appl. No.: 17/840,845

(22) Filed: Jun. 15, 2022

(51) Int. Cl. D02J 1/18; B29C 70/08; B29C 70/10

(52) U.S. Cl. CPC D02J 1/18; B29C 70/08; B29C 70/10; B29L 2031/7146

(57) ABSTRACT

A composite component includes a substrate including a first region and a second region. A plurality of first fiber tows is arranged in the first region and including non-conductive filaments. First stitches attach the plurality of first fiber tows to a first surface of the substrate. A plurality of second fiber tows are arranged in the second region and including conductive filaments. Second stitches attach the plurality of second fiber tows to the first surface of the substrate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to composite components, and more particularly to composite components including hybrid fiber reinforcements.

Vehicles include structural components such as battery covers, hoods, decklids, doors, fenders, liftgates and other structural components. For example, a battery cover may be used to cover a battery system including one or more battery cells. To reduce the weight of the vehicle, some components can be made using composite materials such as carbon fiber.

Some components made using composite materials are attached to the vehicle using steel fasteners. Furthermore, some of the composite components such as battery covers need to include a vent that is made of metal and that is attached to the battery cover using metal fasteners. Interaction between the carbon fiber and the metal fasteners may cause corrosion. Some of the components such as battery covers are also subjected to high temperatures and/or a flame in the event of a battery system failure.

### SUMMARY

A composite component includes a substrate including a first region and a second region. A plurality of first fiber tows is arranged in the first region and including non-conductive filaments. First stitches attach the plurality of first fiber tows to a first surface of the substrate. A plurality of second fiber tows are arranged in the second region and including conductive filaments. Second stitches attach the plurality of second fiber tows to the first surface of the substrate.

In other features, polymer encapsulates the substrate, the plurality of first fiber tows, the first stitches, the plurality of second fiber tows and the second stitches. An opening is formed in the second region of the substrate. A vent includes first perforations and second perforations. Third stitches are threaded through the first perforations and attaching the vent to the first side of the substrate over the opening.

In other features, a polymer membrane is arranged on a first surface of the vent covering the second perforations. The vent further comprises a piercing member arranged over and spaced from the polymer membrane to pierce the polymer membrane when the polymer membrane expands. A metallic mesh is attached by third stitches to the substrate.

In other features, the first fiber tows include glass fiber filaments. The second fiber tows include carbon fiber filaments. At least some of the first stitches have stitch spacing that is different than at least some of the second stitches. At least some of the plurality of second fiber tows arranged in the second region overlap with other ones of the plurality of second fiber tows arranged in the second region. The composite component comprises a battery cover.

A method for manufacturing a composite component includes providing a substrate including a first region and a second region; arranging a plurality of first fiber tows in the first region, wherein the plurality of first fiber tows includes non-conductive filaments; attaching the plurality of first fiber tows using first stitches to a first side of the substrate; arranging a plurality of second fiber tows in the second region, wherein the plurality of second fiber tows includes conductive filaments; and attaching the plurality of second fiber tows using second stitches to the first side of the substrate.

In other features, the method includes encapsulating the substrate, the plurality of first fiber tows, the first stitches, the plurality of second fiber tows and the second stitches in polymer.

In other features, the method includes cutting an opening in the second region of the substrate; arranging a vent including first perforations and second perforations over the opening; and attaching the vent to the substrate using third stitches threaded through the first perforations over the opening on the first side of the substrate.

In other features, the method includes attaching a polymer membrane to a first surface of the vent to cover the second perforations. The method includes arranging a piercing member over and spaced from the polymer membrane to pierce the polymer membrane when the polymer membrane expands relative to the second perforations.

In other features, the method includes arranging a metallic mesh adjacent to the first surface of the substrate; and attaching the metallic mesh to the substrate using third stitches. The first fiber tows include glass fiber filaments and the second fiber tows include carbon fiber filaments. At least some of the first stitches have stitch spacing that differs from at least some of the second stitches.

In other features, the method includes arranging at least some of the plurality of second fiber tows in the second region to overlap with other ones of the plurality of second fiber tows arranged in the second region.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a plan view illustrating two or more different types of fiber tow arranged on and sewn to a substrate in various patterns using a tailored fiber placement (TFP) process according to the present disclosure;

FIG. 2 is a plan view of an example of a composite component including the substrate of FIG. 1 and an integrated mesh material according to the present disclosure;

FIG. 3A is a plan view of another example of a composite component including an integrated vent according to the present disclosure;

FIGS. 3B and 3C are side cross-sectional views showing a vent with a piercing member configured to pierce a thin polymer membrane arranged over the second perforations in the vent according to the present disclosure;

FIG. 4 illustrates a mesh material that is stitched to the substrate according to the present disclosure;

FIGS. 5A and 5B illustrate heat dispersion of composite components without and with the mesh material, respectively;

FIG. 6 is a flowchart for a method of manufacturing the composite component according to the present disclosure;

In the drawings, reference numbers may be reused to identify similar and/or identical elements.

### DETAILED DESCRIPTION

The present disclosure relates to composite components with hybrid fiber reinforcements. While the following description includes examples where the composite components are used for vehicles (e.g., a battery cover), the composite components can be used in other vehicle and non-vehicle applications.

The composite components include hybrid fiber reinforcements in a single preform that is manufactured using tailored fiber placement (TFP). In some examples, carbon or aramid fibers are located in high load bearing areas and glass fibers are located in mounting or flange areas of the battery cover to mitigate corrosion when steel fasteners are used. The composite component uses variable thickness glass and/or carbon fiber in various regions thereof as needed. Variable stitch density is used for draping.

In some examples, the composite component includes an integrated metallic mesh that is stitched to a surface of the substrate prior to over-molding. In some examples, the fiber tows and the mesh are stitched to the same side of the substrate. For example, the composite component may be a battery cover including the integrated metallic mesh on the inner surface facing the battery cells. When one or more of the battery cells fail and generate heat or a flame, the metallic mesh spreads heat into a larger area of the composite component. In some examples, the integrated metallic mesh is a bi-directional mesh with biasing in the length direction. As can be appreciated, electromagnetic compatibility (EMC) performance of the composite component is also improved when using the metallic mesh.

In some examples, the composite component includes an integrated vent. The vent is stitched to the substrate and then over-molded. In some examples, the vent includes a polymer membrane covering perforations in the vent that allow vent gas to pass through the vent. The polymer membrane expands in response to increased vent gas pressure and breaks (or is perforated) when fluid pressure increases in the battery case above a predetermined pressure. In some examples, foil such as aluminum foil is co-molded with or bonded to the composite panel after over-molding for additional thermal performance.

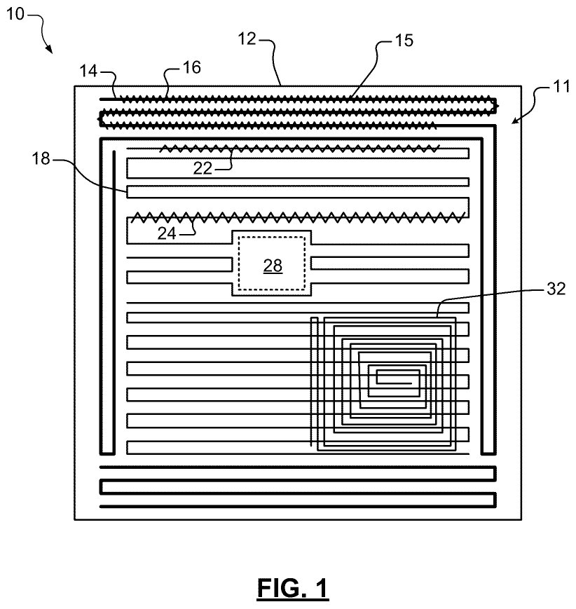

Referring now to FIG. 1, a preform 10 is shown to include fiber tow 11 arranged on a substrate 12 (or packing sheet) in predetermined patterns and attached to the substrate 12 using stiches 15. As will be described further below, the types and/or thicknesses of fiber tow 11 and the placement of or spacing between the fiber tow 11 is varied in different portions of the substrate 12. In some examples, a computer numerical controlled (CNC) sewing machine places the fiber tow 11 and sews the fiber tow 11 on the substrate 12 to the substrate 12 using fixed or variable stiches per unit length.

In some examples, two or more different types of fiber tow 14 and 18 are used. For example, fiber tow 14 including glass fibers may be used in first areas (e.g., outer areas in some examples) and fiber tow 18 including carbon fibers or a mixture of carbon fibers and other fibers may be used in second areas (e.g., inner areas in some examples). The fiber tow 11 are attached to the substrate using stitches 15 (note that only some of the stitches 15 are shown). In this example, the stitches 15 include different stitch spacing at 16, 22, and 24.

The fiber tow 11 may also be arranged with different densities (or spacing between adjacent ones of the fiber tow 11). For example, the fiber tow 11 is shown arranged around edges of an opening 28 and the opening 28 may be trimmed prior to over-molding to allow installation of an integrated vent. Fiber tow 11 may also be arranged and sewn on top of other fiber tow to increase strength in certain locations and to vary thickness.

In some examples, the fiber tows 11 have spacing in a range from 0.25 mm to 1.0 mm. In some examples, the fiber tows have spacing in a range from 0.4 mm to 0.6 mm (e.g., 0.5 mm). In some examples, the fiber tow includes 1 k, 3 k, 12 k, 24 k, 50 k filaments, although other numbers of filaments can be used. In some examples, the fiber tows have principal diameters in a range from 0.5 mm to 4 mm (e.g., 3 mm). In some examples, a repeating pattern of the stitches (similar to a period of a sinusoid) has a spacing along the length of the fiber tow in a range from 5 mm to 25 mm, although other stitch spacing dimensions can be used. In some examples, some of the fiber tows include one type of fiber for the filaments in the fiber tow. In other examples, some of the fiber tows include two or more types of fibers as filaments in the same fiber tow (e.g. carbon/glass, aramid/glass or other combinations).

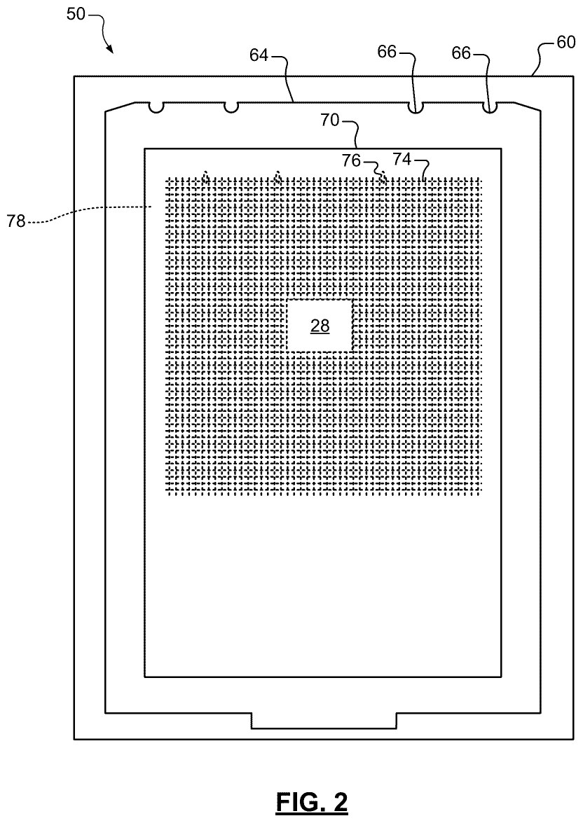

Referring now to FIG. 2, a composite component 50 such as a battery cover is shown to include a preform 60 with a first region 64 and a second region 70. In some examples, the second region 70 is located within the first region 64. However, the first, second and/or other regions may be contiguous or spaced from one another.

In some examples, the first region 64 is made using a first type of fiber tow that is non-conductive. For example, the first type of fiber tow in the first region includes glass fibers and/or aramid fibers. The first region 64 acts as a flange area. In some examples, the second region 70 is made using a second type of fiber tow such as carbon fiber or a mixture of carbon fiber and another type of fiber. In some examples, the composite panel in the first region 64 and/or the second region 70 have a variable thickness. In some examples, a metallic mesh 74 is attached at 76 to portions of a surface 78 of the first region 64 and/or the second region 70 of the composite component 50 using stitches 76. In some examples, the metallic mesh 74 is stitched to the surface 78 of the substrate.

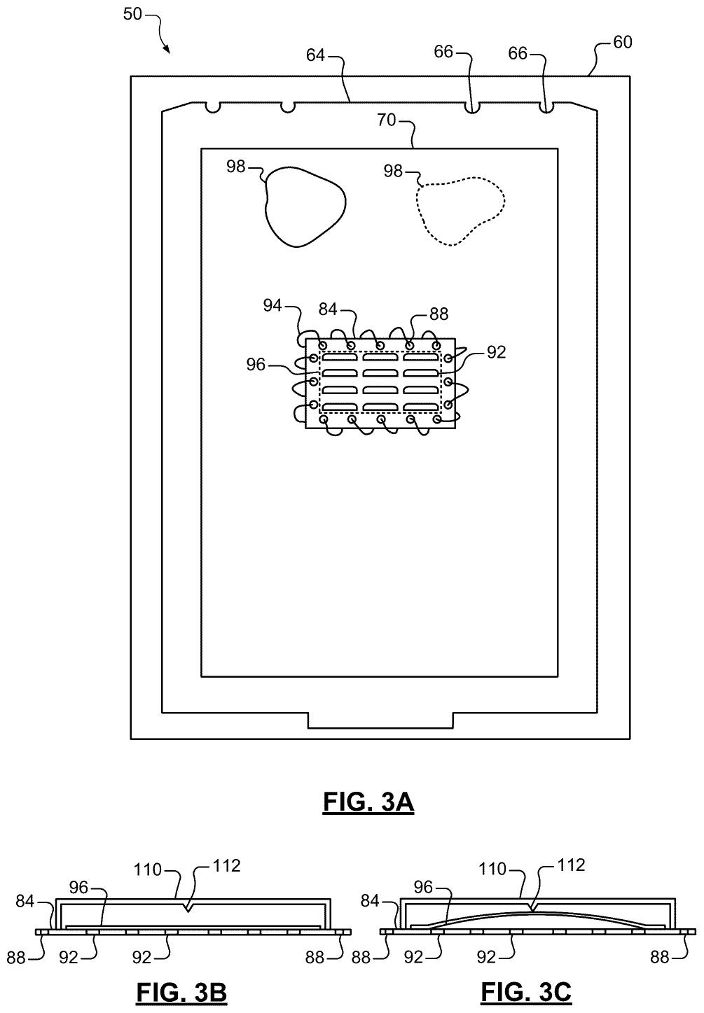

Referring now to FIG. 3A, the composite component 50 further includes a vent 84 located over the opening 28 (FIG. 2) defined in the second region 70. The metallic mesh 74 is omitted in FIG. 2 for purposes of clarity. The vent 84 includes first perforations 88 and second perforations 92. The first perforations 88 are arranged around an edge of the vent 84 and receive stitches 94 to attach the vent 84 over the opening in the second region 70. The second perforations 92 allow fluid such as vent gas to pass through the vent 84. In some examples, a polymer membrane 96 is formed over the second perforations 92.

In some examples, the thickness of the preform 60 varies in a predetermined range from 1.5 mm to 5 mm. Fiber tow principal diameter in the flange areas varies from 2.5 mm to 5 mm. The stitch density is in a range from 0-4000 stitches per m 2 of the preform in critical areas (minimum stitch density at 4 corners of the battery cover) for draping.

In some examples, the metallic mesh 74 has a diameter in a range from 0.25 mm to 1.0 mm and a percentage open area of 40% to 80%. In some examples, the metallic mesh 74 is arranged closer to the inner surface 78 of the composite component 50 such as a battery cover for electromagnetic compatibility (EMC) and to distribute the heat to a wider area of the composite component 50 as will be described below.

In some examples, a foil layer 98 is optionally co-molded or bonded to an inner or outer surface of the preform 60. In some examples, the foil layer 98 has a thickness in a range from 0.1 mm to 1.0 mm. In some examples, the foil layer 98 is made of aluminum, although other materials can be used.

Referring now to FIGS. 3B and 3C, the polymer membrane 96 is bonded or applied to an outer surface of the vent 84. When pressure in the battery cover exceeds a predetermined pressure, the polymer membrane 96 expands and bursts (or is punctured by a piercing member 112 connected by a support structure extending above the outer surface of the vent 84).

Referring now to FIG. 4, the metallic mesh 74 is stitched to the preform using stitches 76 arranged at end of the metallic mesh 74. In other examples, the metallic mesh is braided via TFP.

In some examples, the second perforations 92 include slots having a length in a range from 5 mm to 15 mm and a width in a predetermined range from 0.5 mm to 2.0 mm. In some examples, the second perforations 92 have a length in a range from 5 mm to 25 mm and a width in a range from 5 mm to 15 mm. After over-molding is performed, areas located outside of the first region can be trimmed.

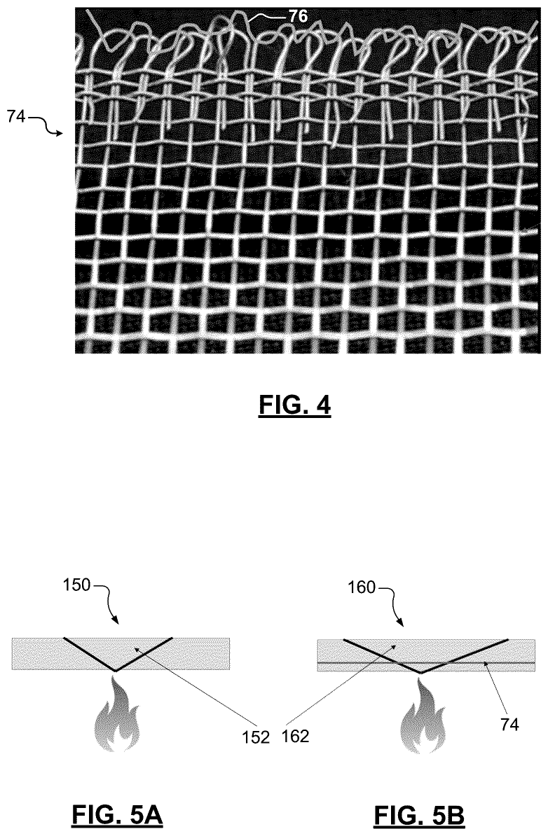

Referring now to FIGS. 5A and 5B, the metallic mesh 74 improves thermal performance of the composite cover. In FIG. 5A, when a composite component 150 according to the prior art is heated by a heat source such as a flame, the composite component 150 spreads the heat in a cone-shaped pattern 152. In FIG. 5B, when a composite component 160 including the metallic mesh 74 according to the present disclosure is heated by a heat source such as a flame, the composite component 160 spreads the heat in a cone-shaped pattern 162. Comparing the cone-shaped pattern 152 to the cone-shaped pattern 162, the metallic mesh 74 spreads the heat with a wider cone-shaped pattern, which spreads the heat into a wider area to improve thermal rejection performance of the composite component 160.

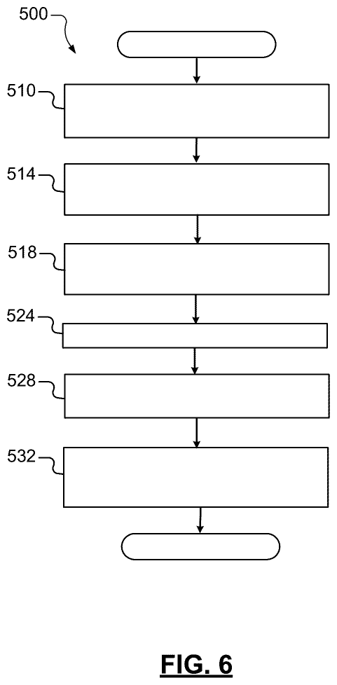

Referring now to FIG. 6, a method 500 for manufacturing the composite component is shown. At 510, fiber tow are arranged and stitched to a preform to create two or more regions. Variable types of fiber tow, spacing, and/or stitching is used. At 514, metallic mesh is stitched to a surface of the preform. At 518, the vent is stitched to a second or outer surface of the preform. At 524, the outer edges of the preform are trimmed. At 528, the preform (with the vent, the metallic mesh and/or the foil) are placed into a molding tool. To prevent resin flowing into the second perforations of the vent (if used), the molding tool includes a seal surrounding the second perforations of the vent to prevent polymer from entering the vents during encapsulation. At 532, a resin transfer molding process or a compression molding process is performed to encapsulate the composite preforms.

In some examples, the fibers are selected from a group consisting of carbon, aramid, glass, basalt, flax, hemp, pineapple, polyethylene, natural, and cellulose. In some examples, the plurality of fibers have a shape that is selected from the group consisting of: cylindrical, flat, or both cylindrical and flat.

Suitable fiber materials may include carbon fibers (e.g., carbon black, carbon nanotubes, talc, fibers derived from polyacrylonitrile and/or pitch precursors), glass fibers (e.g., fiber glass, quartz), basalt fibers, aramid fibers (e.g., KEVLAR®, polyphenylene benzobisoxazole (PBO)), polyethylene fibers (e.g., high-strength ultra-high molecular weight (UHMW) polyethylene), polypropylene fibers (e.g., high-strength polypropylene), natural fibers (e.g., cotton, flax, cellulose, spider silk), and combinations thereof.

In some examples, the polymer material may be a thermoset or thermoplastic material. In some examples, the polymer material includes one or more materials selected from a group consisting of polycarbonate, epoxy, polyurethane, polymethylmethacrylate, a polyamide, styrene-acrylonitrile, methyl methacrylate-acrylonitrile-butadiene-styrene, styrene methyl methacrylate, and/or other polymer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A composite component comprising:
a substrate including a first region and a second region;
a plurality of first fiber tows arranged in the first region and including non-conductive filaments;
first stitches attaching the plurality of first fiber tows to a first surface of the substrate;
a plurality of second fiber tows arranged in the second region and including conductive filaments; and
second stitches attaching the plurality of second fiber tows to the first surface of the substrate.

2. The composite component of claim 1, further comprising polymer encapsulating the substrate, the plurality of first fiber tows, the first stitches, the plurality of second fiber tows and the second stitches.

3. The composite component of claim 1, further comprising:
an opening formed in the second region of the substrate;
a vent including first perforations and second perforations; and
third stitches threaded through the first perforations and attaching the vent to the first side of the substrate over the opening.

4. The composite component of claim 3, further comprising a polymer membrane arranged on a first surface of the vent covering the second perforations.

5. The composite component of claim 4, wherein the vent further comprises a piercing member arranged over and spaced from the polymer membrane to pierce the polymer membrane when the polymer membrane expands.

6. The composite component of claim 1, further comprising:
a metallic mesh; and
third stitches attaching the metallic mesh to the substrate.

7. The composite component of claim 1, wherein:
the first fiber tows include glass fiber filaments; and
the second fiber tows include carbon fiber filaments.

8. The composite component of claim 1, wherein at least some of the first stitches have stitch spacing that is different than at least some of the second stitches.

9. The composite component of claim 1, wherein at least some of the plurality of second fiber tows arranged in the second region overlap with other ones of the plurality of second fiber tows arranged in the second region.

10. The composite component of claim 1, wherein the composite component comprises a battery cover.

11. A method for manufacturing a composite component, comprising:
providing a substrate including a first region and a second region;
arranging a plurality of first fiber tows in the first region, wherein the plurality of first fiber tows includes non-conductive filaments;
attaching the plurality of first fiber tows using first stitches to a first side of the substrate;
arranging a plurality of second fiber tows in the second region, wherein the plurality of second fiber tows includes conductive filaments; and
attaching the plurality of second fiber tows using second stitches to the first side of the substrate.

12. The method of claim 11, further comprising encapsulating the substrate, the plurality of first fiber tows, the first stitches, the plurality of second fiber tows and the second stitches in polymer.

13. The method of claim 11, further comprising:
cutting an opening in the second region of the substrate;
arranging a vent including first perforations and second perforations over the opening; and
attaching the vent to the substrate using third stitches threaded through the first perforations over the opening on the first side of the substrate.

14. The method of claim 13, further comprising attaching a polymer membrane to a first surface of the vent to cover the second perforations.

15. The method of claim 14, wherein arranging a piercing member over and spaced from the polymer membrane to pierce the polymer membrane when the polymer membrane expands relative to the second perforations.

16. The method of claim 11, further comprising:
arranging a metallic mesh adjacent to the first surface of the substrate; and
attaching the metallic mesh to the substrate using third stitches.

17. The method of claim 11, wherein:
the first fiber tows include glass fiber filaments; and
the second fiber tows include carbon fiber filaments.

18. The method of claim 11, wherein at least some of the first stitches have stitch spacing that differs from at least some of the second stitches.

19. The method of claim 11, further comprising arranging at least some of the plurality of second fiber tows in the second region to overlap with other ones of the plurality of second fiber tows arranged in the second region.

20. The method of claim 11, wherein the composite component comprises a battery cover.
